(19) United States
(12) Patent Application Publication
(10) Pub. No.: US 2002/0048110 A1
(43) Pub. Date: Apr. 25, 2002

(54) Amplifier

(76) Inventors: Michiya Sako, Kagoshima (JP); Kazue Tokuchida, Kagoshima (JP)

Correspondence Address: RADER FISHMAN & GRAUER PLLC, LION BUILDING, 1233 20TH STREET N.W., SUITE 501, WASHINGTON, DC, 20036, US

(21) Appl. No.: 09/983,252

(22) Filed: Oct. 23, 2001

(30) Foreign Application Priority Data
Oct. 24, 2000 (JP) P2000-323666

(51) Int. Cl. G11B 5/02

(52) U.S. Cl. 360/68

(57) ABSTRACT

To restrain noise voltage output caused by a rapid change in output current in starting an output stage, a reproduced signal detected by an MR head is amplified by an amplifier and out-put volt-age and output current are outputted, A middle point of the MR head is controlled to always maintain potential of ground level. The output current is controlled by a current control portion (delaying circuit) (not included in FIG. 1) for converting an ON/OFF control signal into a signal having an integration waveform. The signal having the integration waveform is provided with a rise portion having a constant time constant, thereby there is restrained noise voltage output caused by a rapid change in output current, hunting of a power source of an amplifying portion, or inner inductance in a conventional example.

### BACKGROUND OF THE INVENTION

1. Field of the Invention

The present invention relates to an amplifier, particularly to an amplifier in which an output current value is controlled based on ON and OFF control signals.

2. Description of the Related Art

Conventionally, in a magnetic recording and reproducing apparatus such as a magnetic disk, there is used an amplifier (reproducing amplifier) including an MR (magneto-resistive) head for reproducing recorded data.

The MR head is provided with a characteristic in which a resistance value of the MR head is changed in accordance with a change in a magnetic field. Further, the amplifier is normally controlled by a current bias voltage sensing system; that is, bias current flowing to the MR head is supplied from a current source connected to a power source, a change in the resistance value of the MR head in necessary signal frequency band is detected and the change is outputted as a change in a voltage value.

Further, according to the current bias voltage sensing system, a middle point of an MR head circuit is controlled by feedback control such that the middle point is always at ground potential.

Further, according to the magnetic recording and reproducing apparatus, a recording mode and a reproducing mode are repeated at high speed, further, in the recording mode, the amplifier is not used and therefore, with regard to the above-described amplifier, states of start (ON) and stop (OFF) are repeated at high speed.

Meanwhile, according to the above-described conventional amplifier of the current bias voltage sensing system used in the magnetic recording and reproducing apparatus, in starting an output stage of the amplifier, output current rapidly becomes large current Therefore, at such an instance, a power source voltage value applied to an inner circuit is considerably vibrated by influence of an inductance connected between the power source and the ground (GND), that is, an inductance parasitic to wires between an outside power source and an inner portion of IC, in a substrate and between a PAD and a lead frame.

There poses a problem that the vibration of the power source voltage value is leaked to the MR head by influence of parasitic capacitance at an inner portion of the amplifier, amplified by the amplifier and outputted as noise voltage.

Further, when a capacitive load is connected to an output side, by the generated noise voltage, collector current of a transistor included in an output stage of the amplifier is further increased, the power source voltage value applied to the transistor is vibrated further considerably and in the worst case, there also is a possibility of causing abnormal oscillation.

FIG. 7 illustrates graphs showing measured values of changes in output current and output voltage at and after a time point of switching recording/reproducing of the conventional amplifier.

According to the measurement graphs shown in FIG. 7, there is recorded a behavior in which rapid rise and vibration to a certain degree of the output current in an elapse time of about 70 (ns) immediately after rise of the output current, emerge as considerable vibration having a large amplitude in the output voltage.

### SUMMARY OF THE INVENTION

The invention has been carried out in view of the above-described problem in the conventional amplifier and it is an object thereof to provide an amplifier capable of restraining a noise voltage output caused by a rapid change in output current in starting an output stage.

According to the invention, in order to resolve the above-described problem, there is provided an amplifier which is an amplifier having outputting means for controlling an output current based on an ON/OFF control signal, the amplifier comprising amplifying means for amplifying an input signal, integration wave form generating means for generating a signal having an integration waveform by integrating the ON/OFF control signal, and output current controlling means for controlling the output current of the outputting means based on the signal having the integration waveform.

That is, according to the invention, the ON/OFF control signal of the amplifier is converted into the signal having the integration waveform, by using the signal having the integration waveform, the output current of the amplifier including an MR head used for reproducing a record signal, is made to rise with a constant time constant, thereby, there is restrained a noise voltage output caused by hunting of a power source of an amplifying portion by making rapidly changing current flow to an inductance (in correspondence to LI of FIG. 1) in a conventional example.

### BRIEF DESCRIPTION OF THE DRAWINGS

FIG. 1 is a circuit diagram showing a circuit constitution of an amplifying portion of an amplifier according to an embodiment of the invention;

FIGS. 2A through 2C are graphs showing a change in output current of the amplifying portion of the amplifier according to the embodiment of the invention;

FIG. 3 is a circuit diagram showing a circuit constitution of a current control portion (delaying circuit) prescribing output current of the amplifying portion of the amplifier according to the embodiment of the invention;

FIG. 4 is a table showing output voltages of voltage sources V2 and V3 of the current control portion (delaying circuit) prescribing the output current of the amplifying portion of the amplifier according to the embodiment of the invention;

FIG. 5 illustrates timing charts (graphs) for showing operation of the current control portion (delaying circuit) including a time constant for prescribing the output current of the amplifying portion of the amplifier according to the embodiment of the invention;

FIG. 6 illustrates graphs showing measured values of chancres in output current and output voltage at and after a time point- of switching recording/reproducing of the amplifying portion of the amplifier according to the embodiment of the invention; and

FIG. 7 illustrates graphs showing measured values of changes in output current and output voltage at and after a time point of switching recording/reproducing of a conventional amplifier.

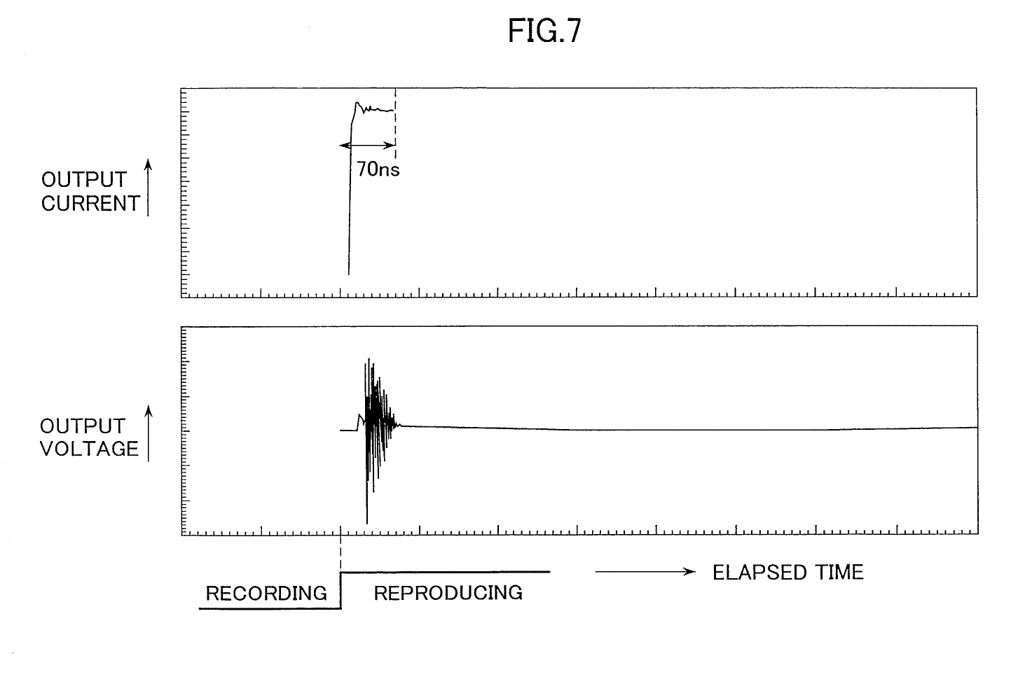

### DETAILED DESCRIPTION OF THE PREFERRED EMBODIMENTS

An explanation will be given of an embodiment of the invention as follows.

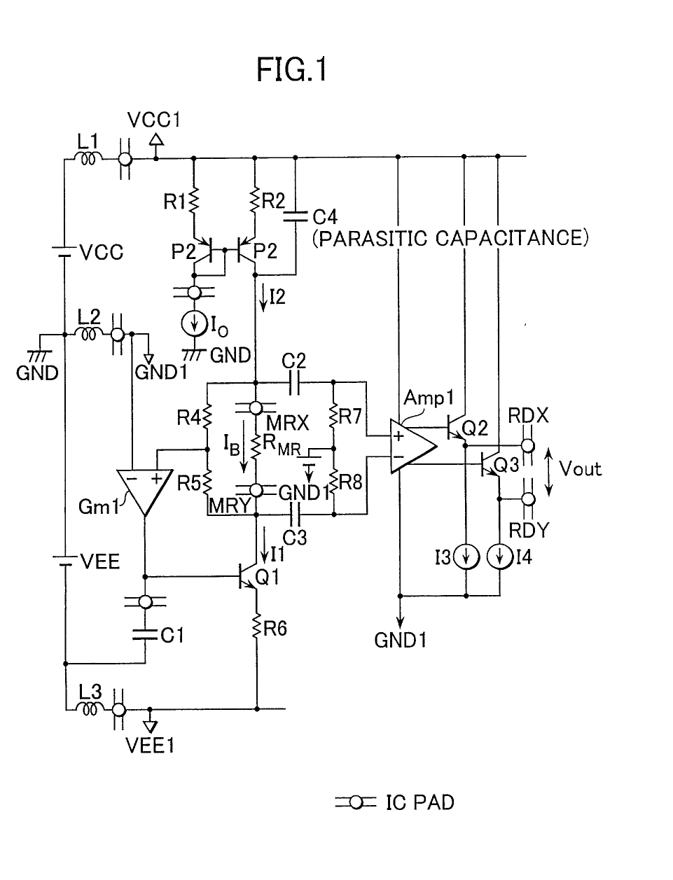

FIG. 1 is a circuit diagram showing a circuit constitution of an amplifying portion of an amplifier according to an embodiment of the invention.

The amplifying portion of the amplifier according to the embodiment includes transistors PI and P2 and resistors R1 and R2 connected to a power supply VCCI and constituting a current mirror circuit, a voltage/current conversion circuit (Gm1) for applying feedback voltage to a middle point of an MR head (R_{MR}), condenser C1 a transistor Q1, resistors R4, R5 and R6, condensers C2 and C3 and resistors R7 and R8 constituting a circuit for cutting a direct current component of detected voltage outputted from the MR head (R_{MR}) , an amplifier (Amp1) at an output stage and transistors Q2 and Q3 constituting an output stage emitter follower circuit.

Further, notation Iₒ designates IC outside current and its current value and notations I3 and I4 designate output currents and their current values.

Further, notation C4 designates parasitic capacitance between the power source VCC1 and the collector of the transistor P2, notations L1, L2 and L3 designate inductances caused by wirings between pads (PAD) and a lead frame and a set substrate, notations VCC and VEE designate outside power sources and notations RDX and RDY designate output terminals (IC pins).

An explanation will be given of operation of the amplifying portion of the amplifier according to the embodiment as follows.

The transistors PI and P2 and resistors R1 and R2 constituting the current mirror circuit, fold back current by the outside current source connected between the collector of the transistor Pi and ground (GND) to thereby flow current I2 flowing at the collector of the transistor P2 to the MR head (R_{MR})

The voltage/current conversion circuit (Gm1), the condenser C1, the transistor Q1 and the resistors R4, R5 and R6 execute feedback such that the middle point of the MR head (R_{MR}) is brought into ground (GND) potential. That is, the feedback is executed such that current I2 flowing from the collector of the transistor P2 to the MR head (R_{MR}) and current I1 flowing from the MR head (R_{MR}) and flowing to the collector of the transistor Q1, become equal to each other.

Thereby, for example, when there is brought about a state in which a current value of current I1 flowing from the MR head (R_{MR}) becomes smaller than a current value of current I2 flowing to the MR head (R_{MR}) , recovering operation is carried out by an order described below.

(1) Potential at an MRX terminal of IC pin and plus (+) terminal of the voltage/current conversion circuit (Gm1), is elevated.

(2) Output current of the voltage/current conversion circuit (Gm1) is increased.

(3) Base potential of the transistor Q1 is elevated.

(4) The current value of current I1 supplied to the collector of the transistor Q1 is increased.

(5) The above-described steps of (1) through (4) are repeated until the current value of current I1 becomes equal to the current value of current I2.

(6) The current value of current I1 and the current value of current I2 become equal to each other.

Further, the resistor R4 and the resistor R5 are installed as resistors respectively having the equal resistance value and therefore . . . when the current values of the currents flowing in the resistor R4 and the resistor R5 are equal to each other, potential of the plus (+) terminal of the voltage/current conversion circuit (Gm1) becomes equal to the potential of the middle point of the MR head (R_{MR}) thereby, the middle point of the MR head (R_{MR}) is brought into the level of the ground (GND) potential.

The condensers C2 and C3 and the resistors R7 and R8 cut the direct current component of the detected voltage outputted from the MR head (R_{MR}) and supply only an alternating current component thereof to the amplifier (Amp1) at a post stage (output stage).

The amplifier (Amp1) of the output- stage amplifies the alternating current component of the detected voltage outputted from the MR head (R_{MR}) and outputs output voltage V_{OUT} to the output terminals PDX and RDY.

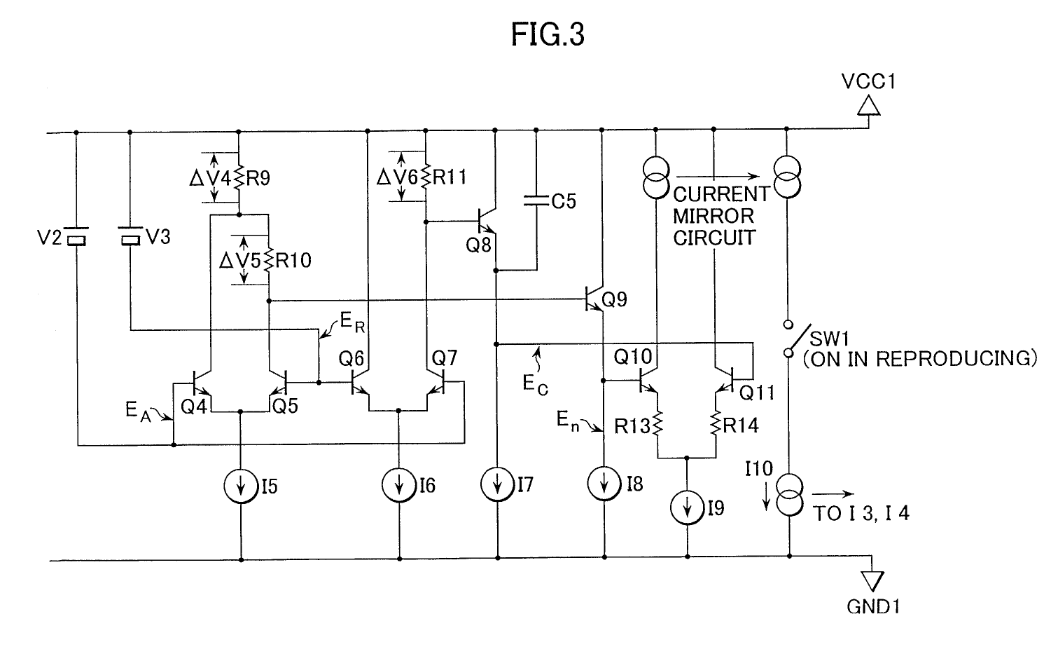

The output currents I3 and I4 are currents controlled by a current control portion (delaying circuit) for determining time constant which will be explained in reference to FIG. 3, described below.

Further, when an amount of a change in the resistance value caused by a change in the magnetic field in the MR head (R_{MR}) is designated by notation ΔR_{MR}, bias current of the MR head (R_{MR}) is designated by notation I_{B} and gain of the amplifier (Amp1) is designated by notation Av, . Voltage of I_{B}×ΔR_{MR}×Av is outputted to the output terminals RDX and RDY.

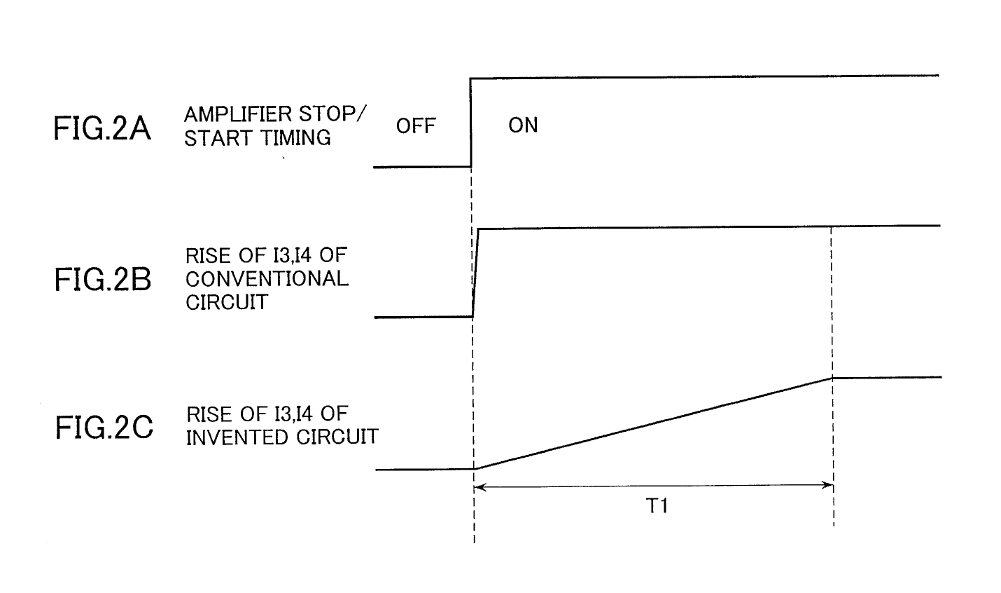

FIG. 2A through FIG. 2C are graphs showing a change in output current of the amplifying portion of the amplifier according to the embodiment of the invention.

FIG. 2A shows a timing at which the amplifying portion is changed from a stop state to a start state, FIG. 2B shows a characteristic of rise of output current (corresponding to output current I3, I4 in FIG. 1) of a. conventional circuit for comparison and FIG. 2C shows a characteristic of rise of output current of the amplifying portion according to the embodiment of the invention, that is, output current I3, I4.

Although according to the conventional circuit, the output current I3, I4 rapidly rises at and after a time point at which the amplifier is changed from the stop state to the start state, the output current I3, I4 of the amplifier portion according to the embodiment of the invention, rises in an integration waveform substantially proportional to elapse of time during elapse of a time period T1 at and after the time point at which the amplifying portion is changed from the stop state to the start state.

FIG. 3 is a circuit diagram showing a circuit constitution of a current control portion (delaying circuit) prescribing output current of the amplifying portion of the amplifier according to the embodiment of the invention.

Transistors (Q4, Q5), (Q6, Q7), (Q10, Q11) constitute differential amplifiers and a condenser C5, resistors R13 and R14 and a current value I7 constitute factors for producing the time constant T1.

Notation E_{A}, designates base potential of the transistors Q4 and Q7, notation E_{B} designates base potential of the transistors Q5 and Q6, notation E_{c} designates base potential of the transistor Q11 and notation E_{D} designates base potential of the transistor Q10.

Notation V2 designates a voltage source for producing base potential E_{A} of the transistors Q4 and Q7 and notation V3 designates a voltage source for producing the base potential E_{B} of the transistors Q5 and Q6.

Voltage drop at a resistor R9 is designated by notation ΔV4, voltage drop at a resistor R10 is designated by notation ΔV5 and voltage drop at a resistor R11 is designated by notation ΔV6, respectively.

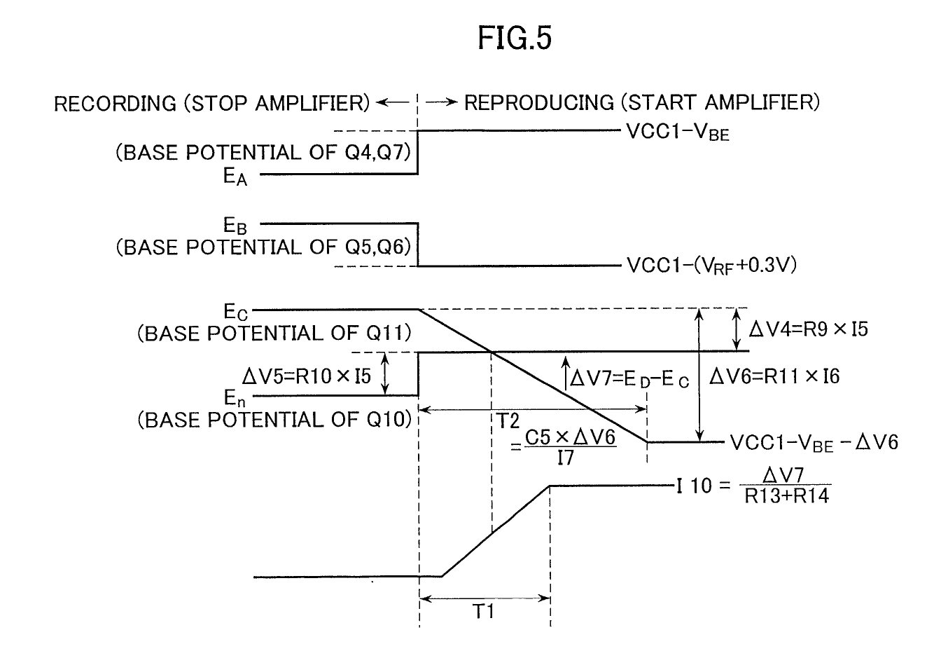

Current I10 is current which will be explained in reference to FIG. 5, described later and which becomes the output currents I3 and I4 of the amplifying portion shown by FIG. 1.

A switch SW1 is made OFF in a recording mode and ON in a reproducing mode.

Power source VCC1 is the same as the power source of the amplifying portion shown in FIG. 1.

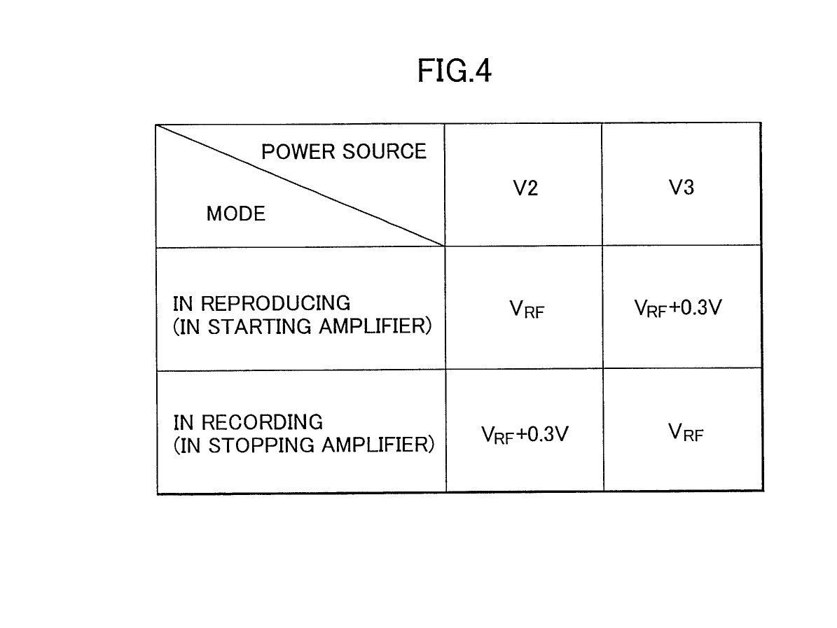

FIG. 4 is a table showing output voltages of the voltage sources V2 and V3 of the current control portion (delaying circuit) prescribing the outputted current of the amplifying portion of the amplifier according to the embodiment of the invention.

The voltage V2 determining the base potential E_{A} of the transistors Q4 and Q7, is outputted to constitute V_{BE} in the reproducing mode (in starting the amplifying portion) and constitute V_{BE}+0.3 (V) in the recording mode (in stopping the amplifying portion). Contrary thereto, the voltage V3 determining the base potential E_{B} of the transistors Q5 and Q6, is outputted to constitute V_{BE}+0.3 (V) in the reproducing mode and constitute V_{BE} in the recording mode.

FIG. 5 illustrates timing charts (graphs) for showing operation of the current control portion (delaying circuit) including the time constant for prescribing the output current of the amplifying portion of the amplifier according to the embodiment of the invention.

An explanation will be given as follows of operation of the current control portion (delaying circuit) including the time constant for prescribing the output current of the amplifying portion of the amplifier according to the embodiment in reference to FIGS. 3 and 4 and using the timing charts shown in FIG. 5.

An explanation will be given successively from the graph shown at an upper portion of FIG. 5 for convenience of explanation.

The base potential E_{A} of the transistors Q4 and Q7 becomes VCC1-V_{BE} at a time point switching to the reproducing mode, that is, simultaneously with starting the amplifying portion shown in FIG. 1.

Incidentally, notation VCC1 designates potential of the power source VCC1.

The base potential E_{B} of the transistors Q5 and Q6 becomes VCC1−(V_{BE}+0.3) at the time point switching to the reproducing mode, that is, simultaneously with starting the amplifying portion shown in FIG. 1.

The base potential E_{C} of the transistor Q11 is linearly lowered from the potential VCC1 at the initial stage to potential VCC1−V_{BE}−ΔV6 at the time point switching to the reproducing mode, that is, simultaneously with starting the amplifying portion shown in FIG. 1, and the base potential E_{C} maintains the potential after elapse of time constant T2. Here, ΔV6 is given by ΔV6=R11×current value I6 and the time constant T2 is given by T2=C5×ΔV6/I7.

The base potential E_{D} of the transistor Q10 rises by ΔV5 at the time point of switching to the reproducing mode, that is, simultaneously with starting the amplifying portion shown in FIG. 1. Here, ΔV5 is given by ΔV5=R10×current value I5.

The current value I10 to be calculated, that is, the output current I3, I4 of the amplifying portion shown in FIG. 1 is given by ΔV7/(R13+R14). Here, ΔV7=potential E_{D} −potential E_{C} and therefore, the calculated value I10 linearly increases with a reduction in the base potential E_{C} of the transistor Q11. Further specifically, the calculated current value I10 increases in accordance with ΔV7/(R13+R14), described above, after elapse of a small period of time from the time point of switching to the reproducing mode, that is, from the time point of starting the amplifying portion shown in FIG. 1 during a time period of elapse of the time constant T1.

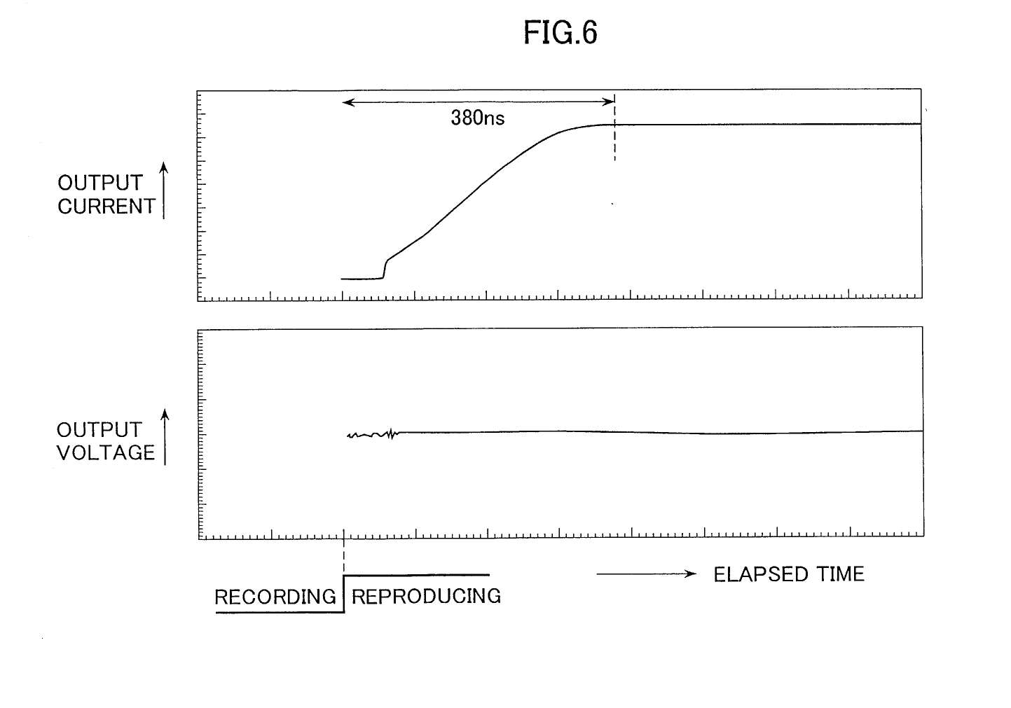

FIG. 6 illustrates graphs showing measured values of changes in output current and output voltage at and after the time point of switching recording/reproducing of the amplifying portion of the amplifier according to the embodiment of the invention.

According to the measurement graphs shown in FIG. 6, it is known that during a time period from the time point of switching to the reproducing mode until elapse of about 380 (ns) the output current of the amplifying portion rises smoothly and vibration of the output voltage is restrained even immediately after the time point of switching to the reproducing mode.

As has been explained above, according to invention, the control signal for making ON/OFF the amplifier is converted into the signal having the integration waveform by using the signal having the integration waveform, the output current of the amplifier including the MR head used in reproducing a record signal, is made to rise with the constant time constant. There can therefore be restrained the noise voltage output caused by a rapid change in the output current, hunting of the power source of the amplifying portion, inner inductance or the like in the conventional example.

What is claimed is:

1. An amplifier which has outputting means for controlling an output current based on an ON/OFF control signal, said amplifier comprising:
amplifying means for amplifying an input signal;
integration waveform generating means for generating a signal having an integration waveform by integrating the ON/OFF control signal; and
output current controlling means for controlling the output current of the outputting means based on the signal having the integration waveform.

2. The amplifier according to claim 1, wherein the ON/OFF control signal is formed in a pulse waveform having predetermined rise portion and fall portion and a portion having a constant amplitude.

3. The amplifier according to claim 2, wherein the integration waveform is provided with a constant final integration amplitude at least in correspondence with the portion of the constant amplitude of the ON/OFF control signal.

4. The amplifier according to claim 1, wherein the input signal is a signal for transmitting information recorded on an information recording medium.

5. The amplifier according to claim 4, wherein the input signal is provided via detecting means for changing a resistance value of a head circuit in correspondence with the information recorded on the information recording medium.

6. The amplifier according to claim 4, wherein the ON/OFF control signal corresponds to a mode of recording the information to the information recording medium and a mode of reproducing the information from the information recording medium.

7. An amplifier connected to an MR head, said amplifier comprising:
a voltage/current converting circuit for applying a feedback voltage to a middle point of the MR head;
means for removing a direct current component of a signal outputted from the MR head;
an amplifier for amplifying an alternating current component of the signal outputted from the MR head; and
a delaying circuit for giving a constant time constant to an output from the amplifier.

8. The amplifier according to claim 7, wherein the voltage/current converting circuit comprising:
a first and a second resistor connected in parallel with the MR head;
a comparator connected between the first and the second resistors; and
a transistor whose control terminal is connected to an output of the comparator.

9. The amplifier according to claim 7, further comprising:
a current mirror circuit connected to one end of the MR head.

10. The comparator according to claim 7, wherein the delaying circuit includes a switching circuit brought into an ON state when a signal is read from the MR head.

11. A magnetic recording and reproducing apparatus having an amplifier having outputting means for controlling an output current based on an ON/OFF control signal, said magnetic recording and reproducing apparatus comprising:
an MR head;
amplifying means for amplifying a signal from the MR head;
integration waveform generating means for generating a signal having an integration waveform by integrating the ON/OFF control signal; and
output current controlling means for controlling the output current of the outputting means based on the signal having the integration waveform.

12. The magnetic recording and reproducing apparatus according to claim 11, wherein the ON/OFF control signal is formed in a pulse waveform having predetermined rise portion and fall portion and a portion having a constant amplitude.

13. The magnetic recording and reproducing apparatus according to claim 11, wherein the integration waveform is provided with a constant final integration amplitude at least in correspondence with the portion of the constant amplitude of the ON/OFF control signal.

14. The magnetic recording and reproducing apparatus according to claim 11, wherein the input signal is a signal for transmitting information recorded on an information recording medium.

15. The magnetic recording and reproducing apparatus according to claim 11, wherein the input signal is provided via detecting means for changing a resistance value of a head circuit in correspondence with the information recorded on the information recording medium.

16. The magnetic recording and reproducing apparatus according to claim 11, wherein the ON/OFF control signal corresponds to a mode of recording the information to the information recording medium and a mode of reproducing the information from the information recording medium.

17. A magnetic recording and reproducing apparatus comprising:
an MR head;
a voltage/current converting circuit for applying a feedback voltage to a middle point of the MR head;
means for removing a direct current component of a signal outputted from the MR head;
an amplifier for amplifying an alternating current component of the signal outputted from the MR head; and
a delaying circuit for giving a constant time constant to an output from the amplifier.

18. The magnetic recording and reproducing apparatus according to claim 17, wherein the voltage/current converting circuit comprising:
a first and a second resistor connected in parallel with the MR head;
a comparator connected between the first and the second resistors; and
a transistor a control terminal of which is connected to an output of the comparator.

19. The magnetic recording and reproducing apparatus according to claim 17, wherein the amplifier includes a current mirror circuit connected to one end of the MR head.

20. The magnetic recording and reproducing apparatus according to claim 17, wherein the delaying circuit includes a switching circuit brought into an ON state when a signal is read from the MR head.
